(19) United States
(12) Patent Application Publication
(10) Pub. No.: US 2024/0074422 A1
(43) Pub. Date: Mar. 7, 2024

(54) Fishing Rod Securing Device for Dock

(71) Applicant: Kenneth Riddle, Lumby (CA)

(72) Inventor: Kenneth Riddle, Lumby (CA)

(21) Appl. No.: 17/900,956

(22) Filed: Sep. 1, 2022

(51) Int. Cl. A01K 97/10

(52) U.S. Cl. CPC A01K 97/10

(57) ABSTRACT

A device for securing a fishing rod holder to a dock is disclosed herein. The device includes an elongated support rod, a crossbar, an abutment portion, a holder portion and a biasing mechanism. The crossbar is insertable into a drainage space between adjacent dock boards when parallel therewith and rotatable such that the crossbar is unable to be pulled back through the drainage space without rotating the crossbar to its original (parallel) position. The crossbar and the abutment portion located thereabove clamp to an underside and topside of the adjacent boards (respectively) to secure the device to the dock.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of fishing accessories of existing art and more specifically relates to a device for securing a fishing rod holder to a dock.

### RELATED ART

Fishing is an extremely popular activity in many areas of the world and performed for various reasons, from recreational to commercial. Fishing typically involves the use of a fishing rod and a fishing line with bait and a hook on the end; the bait and hook are placed in a body of water and the bait is used to lure the fish to the hook.

Many individuals fish into an open body of water such as a lake or ocean. In this setting, the individual often sets up on a dock to wait for the fish to take the bait and hook onto the fishing line. This can take a long period of time and as such, fishing rod holders have been introduced into the fishing accessory market. Fishing rod holders are used for holding fishing rods so that the individual does not need to physically do so themselves. However, fishing rod holders in the current art are problematic as they are often unsteady on the dock, resulting in the fishing rod falling or being moved/taken by fish; or require permanent mounting to the dock to be sufficiently stable. Thus, a suitable solution is desired.

### SUMMARY OF THE INVENTION

In view of the foregoing disadvantages inherent in the known fishing rod holder art, the present disclosure provides a novel fishing rod securing device for dock. The general purpose of the present disclosure, which will be described subsequently in greater detail, is to provide a device to secure a fishing rod holder, and thus a fishing rod, to a dock. As such, the fishing rod holder and fishing rod are unable to be moved or removed by fish.

A device for securing a fishing rod holder to a dock is disclosed herein. The dock of the like having a drainage space between adjacent boards; the fishing rod holder including an attachment portion. The device may include an elongated support rod, a crossbar, an abutment portion, a holder portion and a biasing mechanism. The crossbar may be attached to a bottom end of the elongated support rod and oriented perpendicularly thereto. The crossbar may be configured for insertion through the drainage space and movable between a locked position and an unlocked position. Particularly, the locked position may include the crossbar being abutted against an underside of the adjacent boards and substantially perpendicular thereto and the unlocked position may include the crossbar being substantially parallel to the adjacent boards.

The abutment portion may concentrically surround a bottom section of the elongated support rod and include a flat bottom end located above the crossbar. The flat bottom end may be configured to abut a topside of the adjacent boards when the crossbar is inserted through the drainage space. The holder portion may be attached to a top section of the elongated support rod and concentric therewith. A top holder end of the holder portion may be configured to engage with the attachment portion of the fishing rod holder and attach the fishing rod holder to the device.

The biasing mechanism may be disposed within an interior of the abutment portion and in contact with a bottom holder end of the holder portion. The biasing mechanism may be configured to bias the crossbar toward the locked position, thereby locking the adjacent boards between the crossbar and the abutment portion and securing the device to the dock.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a fishing rod securing device for dock, constructed and operative according to the teachings of the present disclosure.

FIG. 1 is a perspective view of a device being used for securing a fishing rod holder to a dock, according to an embodiment of the disclosure.

FIG. 2 is a close-up perspective view of the device illustrating a crossbar in an unlocked position whereby the crossbar is substantially parallel to adjacent dock boards, according to an embodiment of the present disclosure.

FIG. 3 is a close-up perspective view of the device illustrating the crossbar in a locked position, whereby the crossbar is substantially perpendicular to the adjacent dock boards and abutting an underside thereof, according to an embodiment of the present disclosure.

FIG. 4 is a cross-section view of the device of FIG. 2 illustrating the crossbar in the unlocked position, according to an embodiment of the present disclosure.

FIG. 5 is a cross-section view of the device of FIG. 3 illustrating the crossbar in the locked position, according to an embodiment of the present disclosure.

FIG. 6 is a perspective view of the device including a holder portion, an abutment portion, an elongated support rod and the crossbar, according to an embodiment of the disclosure.

FIG. 7 is a partial exploded view of the device including the holder portion, the abutment portion, the elongated support rod, the crossbar and a biasing mechanism, according to an embodiment of the disclosure.

The various embodiments of the present invention will hereinafter be described in conjunction with the appended drawings, wherein like designations denote like elements.

### DETAILED DESCRIPTION

As discussed above, embodiments of the present disclosure relate to a fishing rod holder and more particularly to a fishing rod securing device for dock. Generally, the fishing rod securing device for dock may include a crossbar insertable into a drainage space between adjacent dock boards and rotatable such that the crossbar is unable to be pulled back through the drainage space (without rotating the crossbar to its original position). The crossbar and a shaft located thereabove clamp to an underside and a topside of the adjacent boards (respectively) to secure the fishing rod securing device for dock to the dock.

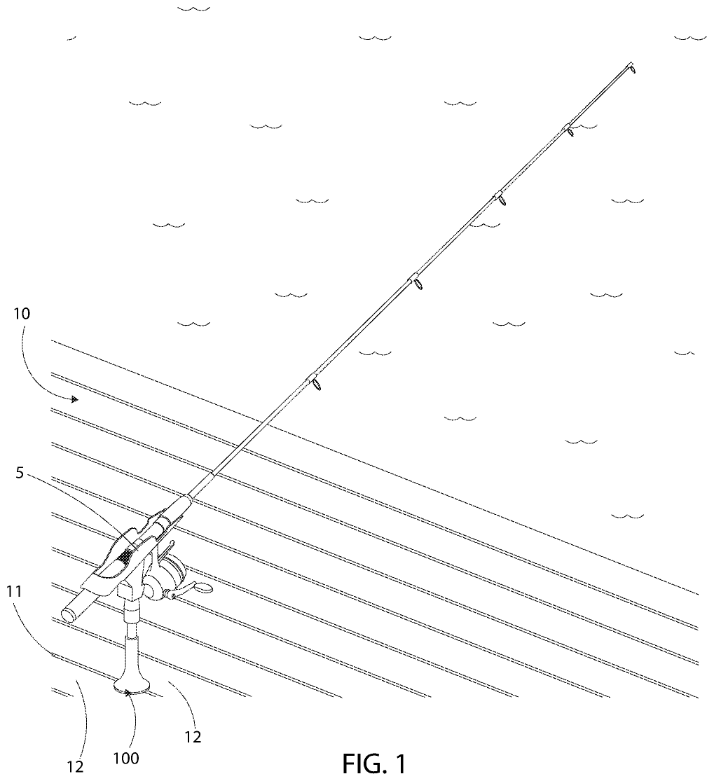

Referring now more specifically to the drawings by numerals of reference, there is shown in FIGS. 1-7, various views of a device 100. The device 100 may include an elongated support rod 110, a crossbar 120, an abutment portion 130, a holder portion 140 and a biasing mechanism 150. As shown in these figures, the device 100 may be used for securing a fishing rod holder 5 and thus a fishing rod, to a dock 10. Particularly, as shown in FIGS. 1-5, the dock 10 may preferably be of the like having a drainage space 11 between adjacent boards 12. The fishing rod holder 5 may include an attachment portion 6. For example, the attachment portion 6 may include a shaft.

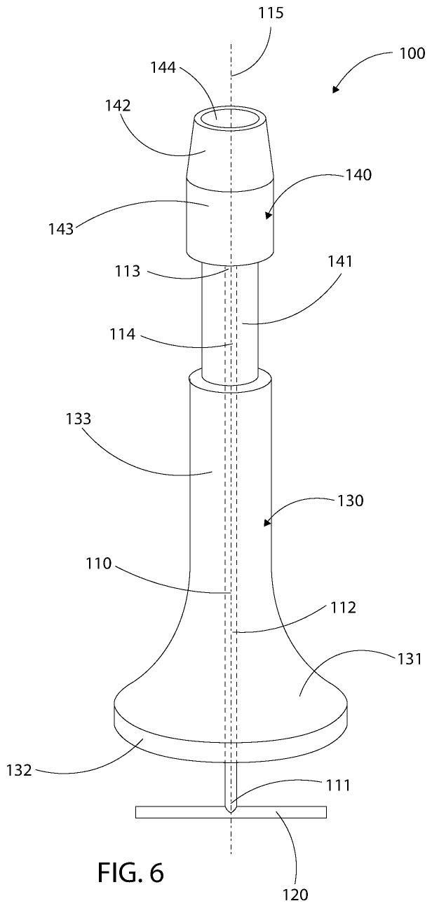

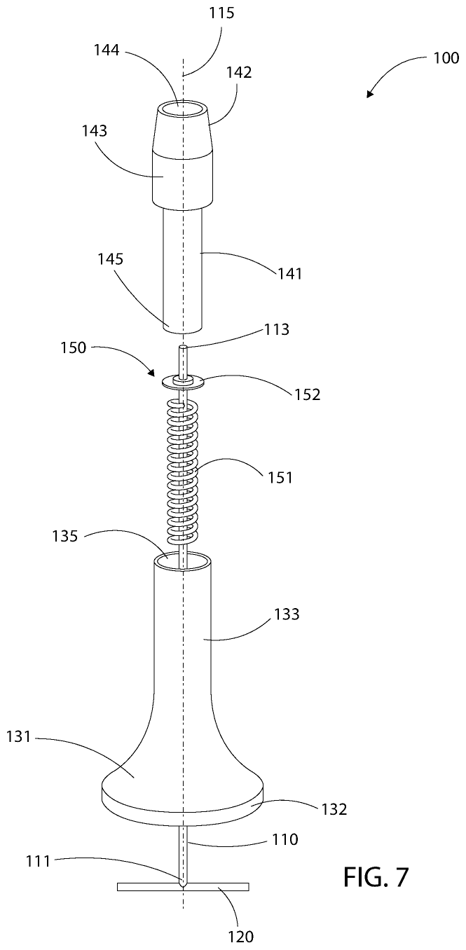

The elongated support rod 110 may include a bottom end 111 opposite a top end 113 and an elongated length therebetween (the elongated support rod 110 is shown via broken lines in FIG. 6 for the sake of clarity). The elongated length may define a vertical axis 115 (FIGS. 6-7) relative to the adjacent (horizontal) boards 12 (FIGS. 1-5). As shown, the crossbar 120 may be attached to the bottom end 111 of the elongated support rod 110 and oriented perpendicular thereto.

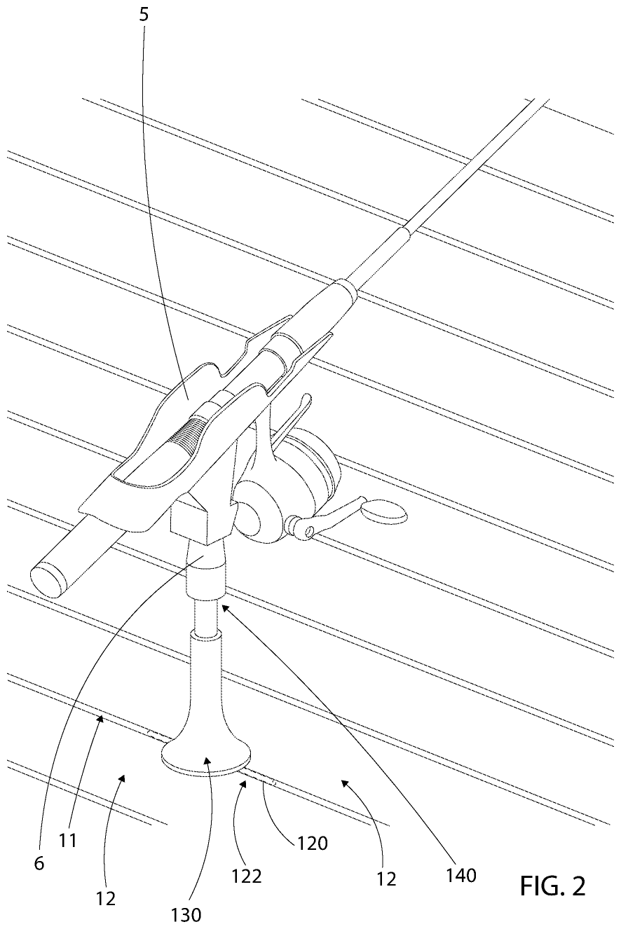

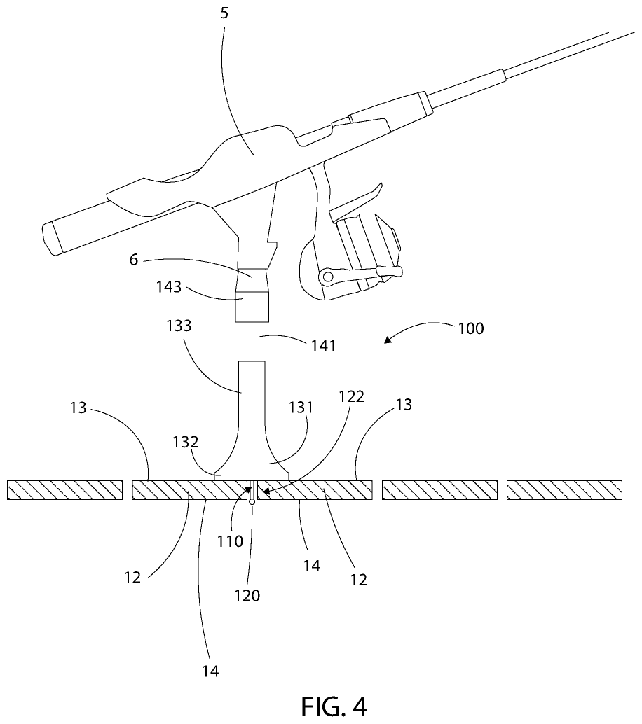

As shown in FIGS. 2-5, the crossbar 120 may be configured for insertion through the drainage space 11. Particularly, the crossbar 120 may be sized for insertion through the drainage space 11 when substantially parallel to the adjacent boards 12, as shown in FIG. 2 and FIG. 4. For example, the crossbar 120 may include a diameter lesser than a width of the drainage space 11, thereby enabling the crossbar 120 to be inserted down through the drainage space 11 when substantially parallel to the adjacent boards 12.

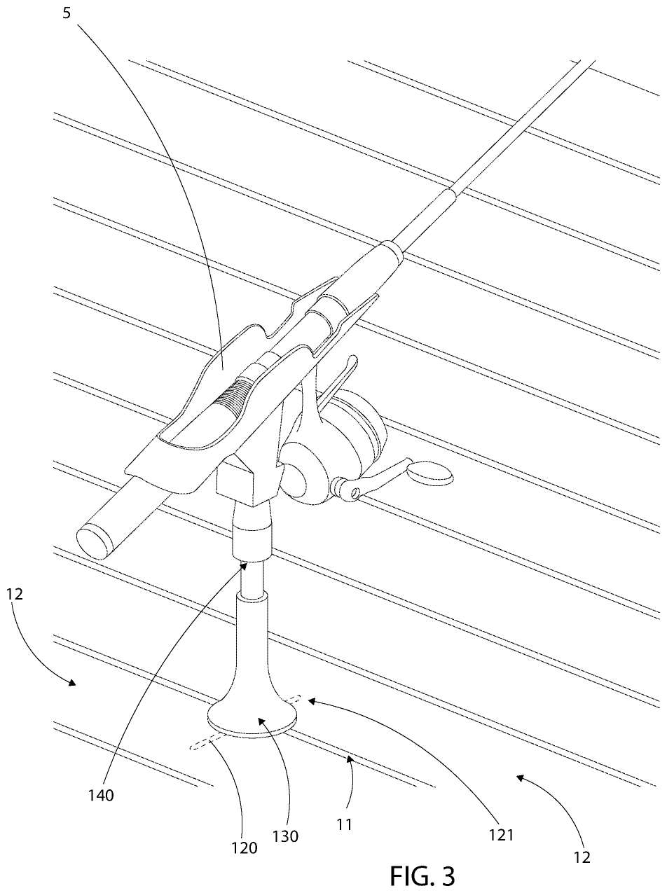

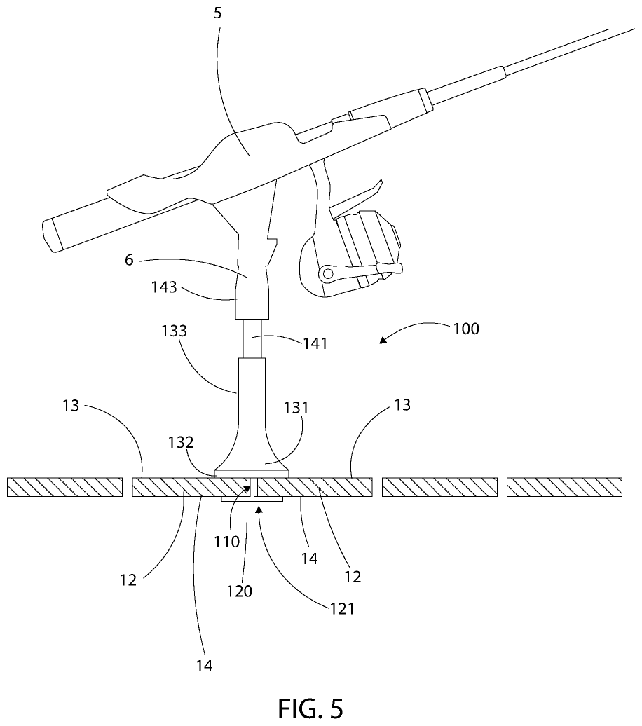

Further, the crossbar 120 may further be sized such that the crossbar 120 is prevented from being pulled up through the drainage space 11 when substantially perpendicular to the adjacent boards 12, as is shown in FIG. 3 and FIG. 5. For example, the crossbar 120 may include a length greater than the width of the drainage space 11, thereby preventing the crossbar 120 from being pulled up through the drainage space 11 when substantially perpendicular to the adjacent boards 12.

As shown in FIGS. 2-5, the crossbar 120 may be movable between a locked position 121 and an unlocked position 122 (the crossbar 120 is shown via broken lines in FIGS. 2-3 for the sake of clarity and to aid in understanding that the crossbar 120 is inserted through the drainage aperture 11). The locked position 121 may include the crossbar 120 being abutted against an underside 14 of the adjacent boards 12 and substantially perpendicular thereto, as shown in FIG. 3 and FIG. 5. The unlocked position 122 may include the crossbar 120 being substantially parallel to the adjacent boards 12, as shown in FIG. 2 and FIG. 4 (and therefore being able to be pulled through the drainage space 11).

As shown in these figures and particularly in FIGS. 6-7, the abutment portion 130 may concentrically surround a bottom section 112 of the elongated support rod 110. The abutment portion 130 may particularly include a generally conical section 131 tapering into a first shaft section 133 located above the conical section 131. The conical section 131 may include a flat bottom end 132 located above the crossbar 120 and configured to abut a topside 13 of the adjacent boards 12 when the crossbar 120 is inserted through the drainage space 11, as shown in FIGS. 2-5. The flat bottom end 132 and a top of the crossbar 120 may define a space therebetween for holding the adjacent boards 12 therewithin. In some embodiments, the flat bottom end 132 may be circular. Further, the abutment portion may be made from a non-slip material, such as (but not limited to) a rubber material. This may add friction between the flat bottom end 132 and the topside 13 of the adjacent boards 12 and thus further prevent movement of the device 100 when secured to the dock 10.

The holder portion 140 may be attached to a top section 114 of the elongated support rod 110 and concentric therewith. As shown in FIGS. 1-5, a top holder end 142 of the holder portion 140 may be configured to engage with the attachment portion 6 of the fishing rod holder 5 and attach the fishing rod holder 5 to the device 100. For example, as discussed above, the fishing rod holder 5 may include a shaft. As such, the top holder end 142 of the holder portion 140 may include a slot 144 (as shown in FIGS. 6-7) disposed therein, configured to receive the shaft. In some embodiments, the slot 144 may include a locking mechanism (not illustrated) such as (but not limited to) grooves for clamping onto grooves on the shaft.

As shown, the holder portion 140 may include a second shaft section 141 and a sleeve section 143 located thereabove. The sleeve section 143 may include the top holder end 142. The second shaft section 141 may include a lesser diameter than the first shaft section 133. The first shaft section 133 and the second shaft section 141 may be tubular. However, it should be appreciated that the shaft sections are not limited to a tubular shape. Further, the sleeve section 143 may include a greater diameter than the second shaft section 141 and provide a handle for use of the device 100, as will be discussed in greater detail below.

The biasing mechanism 150 may be disposed within an interior of the abutment portion 130 and in contact with a bottom holder end 145 of the holder portion 140. Further, the top end 113 of the elongated support rod 110 may attach to the bottom holder end 145 of the holder portion 140. The biasing mechanism 150 may be configured to bias the crossbar 120 toward the locked position 121. Particularly, the biasing mechanism 150 may be configured to urge the crossbar 120 (when the crossbar 120 is inserted in through the drainage space 11 and positioned substantially perpendicular to the adjacent boards 12) against the underside 14 of the adjacent boards 12, thereby locking the adjacent boards 12 between the crossbar 120 and the abutment portion 130 (already abutting the topside 13 of the adjacent boards 12 when the crossbar 120 is inserted through the drainage space 11) and securing the device 100 to the dock 10.

As shown in FIG. 7, the biasing mechanism 150 may include a spring. Preferably, the spring may include a compression spring 151. As such, when compressed, the compression spring 151 may be configured to bias the crossbar 120 toward the locked position 121 (again, when the crossbar 120 is inserted in the drainage space 11 and positioned substantially perpendicular to the adjacent boards 12). As the compression spring 151 tries to return to its relaxed state it is prevented as the crossbar 120 is located underneath the adjacent boards 12. As such, the crossbar 120 is urged against the underside 14 of the adjacent boards 12.

As discussed above, the second shaft section 141 may include a lesser diameter than the first shaft section 133. As shown in FIGS. 6-7, the bottom holder end 145 of the first shaft section 133 may be inserted into a top 135 of the first shaft section 133 and in contact with the compression spring 151. In some embodiments, the holder portion 140 may be configured to rotate about the vertical axis 115 and this rotation may cause compression of the compression spring 151 and movement of the crossbar 120 into the locked position 121 (or into the substantially perpendicular position). In some embodiments, as shown in FIG. 7, the biasing mechanism 150 may further include a plate 152 attached atop the compression spring 151 and in contact with the bottom holder end 145 (and also concentric with the elongated support rod 110) to aid the holder portion 140 in compressing the compression spring 151 and moving the elongated support rod 110.

Particularly, application of a downward rotational force to the holder portion 140 may simultaneously (when the crossbar 120 is inserted through the drainage space 11) compress the compression spring 151, push the elongated support rod 110 downward and rotate the crossbar 120 into the substantially perpendicular position relative to the adjacent boards 12. In this embodiment, releasing the force causes the compression spring 151 to urge the crossbar 120 upward against the bottom surface of the adjacent boards 12.

As discussed above, the sleeve section 143 of the holder portion 140 may provide the handle. As such, the sleeve section 143 may be grasped by a user to provide the downward rotational force. Particularly, in use, a user may grasp the sleeve section 143 of the holder portion 140 and insert the crossbar 120 into the drainage space 11, with the crossbar 120 being substantially parallel to the adjacent boards 12. The abutment portion 130 may consequently abut the topside 13 of the adjacent boards 12. The user may then apply the downward rotational force to the holder portion 140, thus compressing the compression spring 151, moving the elongated support rod 110 downward and rotating the crossbar 120 to a substantially perpendicular position relative to the adjacent boards 12. Preferably, the user may rotate the holder portion 140 90 degrees.

The user may then release the force (by taking their hand off of the sleeve section 143), and the compression spring 151 may then try to decompress and return to its relaxed state. This urges the crossbar 120 into the underside 14 of the adjacent boards 12, preventing the compression spring 151 from returning to its relaxed state and thereby urging the crossbar 120 against the underside 14 of the adjacent boards 12. Thus, the adjacent boards 12 are locked between the abutment portion 130 and the crossbar 120, preventing the device 100 from being moved.

It should be noted that certain steps are optional and may not be implemented in all cases. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods of use are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed:

1. A device for securing a fishing rod holder to a dock of the like having a drainage space between adjacent boards, the fishing rod holder including an attachment portion, the device comprising:
an elongated support rod;
a crossbar attached to a bottom end of the elongated support rod and oriented perpendicularly thereto, the crossbar configured for insertion through the drainage space and movable between a locked position and an unlocked position, the locked position including the crossbar being abutted against an underside of the adjacent boards and substantially perpendicular thereto, the unlocked position including the crossbar being substantially parallel to the adjacent boards;
an abutment portion concentrically surrounding a bottom section of the elongated support rod, the abutment portion including a flat bottom end located above the crossbar and configured to abut a topside of the adjacent boards when the crossbar is inserted through the drainage space;
a holder portion attached to a top section of the elongated support rod and concentric therewith, a top holder end of the holder portion configured to engage with the attachment portion of the fishing rod holder and attach the fishing rod holder to the device; and
a biasing mechanism disposed within an interior of the abutment portion and in contact with a bottom holder end of the holder portion, the biasing mechanism configured to bias the crossbar toward the locked position, thereby locking the adjacent boards between the crossbar and the abutment portion and securing the device to the dock.

2. The device of claim 1, wherein the biasing mechanism includes a spring.

3. The device of claim 2, wherein the spring is a compression spring.

4. The device of claim 1, wherein the crossbar includes a diameter lesser than a width of the drainage space, thereby enabling the crossbar to be inserted down through the drainage space when substantially parallel to the adjacent boards.

5. The device of claim 4, wherein the crossbar includes a length greater than the width of the drainage space, thereby preventing the crossbar from being pulled up through the drainage space when substantially perpendicular to the adjacent boards.

6. The device of claim 5, wherein the abutment portion includes a generally conical section tapering into a first shaft section thereabove, the generally conical section including the flat bottom end.

7. The device of claim 6, wherein the flat bottom end is circular.

8. The device of claim 7, wherein the holder portion includes a second shaft section and a sleeve section located thereabove, the sleeve section including a greater diameter than the second shaft section.

9. The device of claim 8, wherein the second shaft section is of a lesser diameter than the first shaft section.

10. The device of claim 9, wherein the bottom holder end of the first shaft section is inserted into a top of the first shaft section and in contact with the compression spring.

11. The device of claim 10, wherein the top holder end includes a slot disposed therein.

12. The device of claim 11, wherein application of a downward rotational force to the holder portion when the crossbar is inserted through the drainage space simultaneously compresses the compression spring, pushes the elongated support rod downward and rotates the crossbar into a substantially perpendicular position relative to the adjacent boards.

13. The device of claim 12, wherein release of the downward rotational force causes the compression spring to urge the crossbar upward against the underside of the adjacent boards, thereby holding the adjacent boards between the crossbar and the abutment section and securing the device to the dock.

14. The device of claim 13, wherein the sleeve section provides a handle for a user to apply the downward rotational force.

15. The device of claim 14, wherein the first shaft section and the second shaft section are tubular.

16. A device for securing a fishing rod holder to a dock of the like having a drainage space between adjacent boards, the fishing rod holder including an attachment portion, the device comprising:
an elongated support rod;
a crossbar attached to a bottom end of the elongated support rod and oriented perpendicularly thereto, the crossbar configured for insertion through the drainage space and movable between a locked position and an unlocked position, the locked position including the crossbar being abutted against an underside of the adjacent boards and substantially perpendicular thereto, the unlocked position including the crossbar being substantially parallel to the adjacent boards, the crossbar including a diameter lesser than a width of the drainage space, thereby enabling the crossbar to be inserted down through the drainage space when substantially parallel to the adjacent boards, the crossbar further including a length greater than the width of the drainage space, thereby preventing the crossbar from being pulled up through the drainage space when substantially perpendicular to the adjacent boards;
an abutment portion concentrically surrounding a bottom section of the elongated support rod, the abutment portion including a flat bottom end located above the crossbar and configured to abut a topside of the adjacent boards when the crossbar is inserted through the drainage space;
a holder portion attached to a top section of the elongated support rod and concentric therewith, a top holder end of the holder portion configured to engage with the attachment portion of the fishing rod holder and attach the fishing rod holder to the device, the top holder end including a slot disposed therein; and
a biasing mechanism disposed within an interior of the abutment portion and in contact with a bottom holder end of the holder portion, the biasing mechanism configured to bias the crossbar toward the locked position, the biasing mechanism including a compression spring;
wherein application of a downward rotational force to the holder portion when the crossbar is inserted through the drainage space simultaneously compresses the compression spring, pushes the elongated support rod downward and rotates the crossbar into a substantially perpendicular position relative to the adjacent boards; and
wherein release of the downward rotational force causes the compression spring to urge the crossbar upward against the underside of the adjacent boards, thereby locking the adjacent boards between the crossbar and the abutment section and securing the device to the dock.

17. The device of claim 16, wherein the abutment portion includes a generally conical section tapering into a first shaft section thereabove, the generally conical section including the flat bottom end, and wherein the flat bottom end is circular.

18. The device of claim 17, wherein the holder portion includes a second shaft section and a sleeve section located thereabove, the sleeve section including a greater diameter than the second shaft section, and wherein the sleeve section provides a handle for a user to apply the downward rotational force.

19. The device of claim 18, wherein the second shaft section is of a lesser diameter than the first shaft section, and wherein the bottom holder end of the first shaft section is inserted into a top of the first shaft section and in contact with the compression spring.

20. A device for securing a fishing rod holder to a dock of the like having a drainage space between adjacent boards, the fishing rod holder including an attachment portion, the device comprising:
an elongated support rod;
a crossbar attached to a bottom end of the elongated support rod and oriented perpendicularly thereto, the crossbar configured for insertion through the drainage space and movable between a locked position and an unlocked position, the locked position including the crossbar being abutted against an underside of the adjacent boards and substantially perpendicular thereto, the unlocked position including the crossbar being substantially parallel to the adjacent boards, the crossbar including a diameter lesser than a width of the drainage space, thereby enabling the crossbar to be inserted down through the drainage space when substantially parallel to the adjacent boards, the crossbar further including a length greater than the width of the drainage space, thereby preventing the crossbar from being pulled up through the drainage space when substantially perpendicular to the adjacent boards;
an abutment portion concentrically surrounding a bottom section of the elongated support rod, the abutment portion including a generally conical section tapering into a first shaft section thereabove, the generally conical section including a flat bottom end located above the crossbar and configured to abut a topside of the adjacent boards when the crossbar is inserted through the drainage space, the flat bottom end being circular;
a holder portion attached to a top section of the elongated support rod and concentric therewith, the holder portion including a second shaft section and a sleeve section located thereabove, the sleeve section including a greater diameter than the second shaft section and providing a handle for use of the device, the sleeve section including a top holder end configured to engage with the attachment portion of the fishing rod holder and attach the fishing rod holder to the device, the top holder end including a slot disposed therein; and
wherein the second shaft section is of a lesser diameter than the first shaft section, and wherein the bottom holder end of the first shaft section is inserted into a top of the first shaft section and in contact with the compression spring;
wherein application of a downward rotational force to the holder portion when the crossbar is inserted through the drainage space simultaneously compresses the compression spring, pushes the elongated support rod downward and rotates the crossbar into a substantially perpendicular position relative to the adjacent boards; and
wherein release of the downward rotational force causes the compression spring to urge the crossbar upward against the underside of the adjacent boards, thereby locking the adjacent boards between the crossbar and the abutment section and securing the device to the dock.
